(19) United States
(12) Patent Application Publication
(10) Pub. No.: US 2020/0080639 A1
(43) Pub. Date: Mar. 12, 2020

(54) Method and Device for High-Temperature Sealing

(71) Applicant: HiFunda, LLC, Salt Lake City, UT (US)

(72) Inventors: Jesse Nachlas, Brighton, UT (US); Kyu B. Han, Salt Lake City, UT (US); Isaac Corn, Bolivar, MO (US); Brian Jacques, Meridian, ID (US); Darryl P. Butt, Salt Lake City, UT (US); Balakrishnan Nair, Sandy, UT (US); James Steppan, Park City, UT (US)

(21) Appl. No.: 16/565,136

(22) Filed: Sep. 9, 2019

Related U.S. Application Data
(60) Provisional application No. 62/728,449, filed on Sep. 7, 2018.

(51) Int. Cl. F16J 15/08

(52) U.S. Cl. CPC F16J 15/0806; F16J 15/0887

(57) ABSTRACT

Methods and devices for high-temperature sealing of metallic components to ceramic components. The disclosed methods and devices for sealing enable a first environment containing one or more fluids to be isolated from at least one other environment containing one or more fluids. The seal may operate at least part of the time at an elevated temperature, such as a temperature above 100° C., above 300° C., and, in some embodiments, as high as 1000° C. In a typical embodiment, the elevated temperature may be in the range of 600-800° C. The first and/or second environments may be at elevated pressures for at least some fraction of the time. The elevated pressure may be above 100 psig, above 500 psig, and, in some embodiments, as high as 15,000 psig. In a typical embodiment, the elevated pressure may be in the range of 1,000-5,000 psig, and more specifically 1,500-3,000 psig.

### CROSS-REFERENCE TO RELATED APPLICATION

This application claims the benefit of U.S. Provisional Application No. 62/728,449, filed Sep. 7, 2018, which is incorporated by reference.

### FIELD OF THE INVENTION

This invention describes methods and devices for high-temperature sealing. Some embodiments of this invention describe methods and devices for sealing metallic components to ceramic components. Some embodiments of this invention describe methods and devices for sealing such that a first environment containing one or more fluids may be isolated from at least one other environment containing one or more fluids. In some embodiments, the seal may be expected to operate at least part of the time at an elevated temperature. In some embodiments, the elevated temperature may be above 100° C. In some preferred embodiments, the elevated temperature may be above 300° C., and as high as 1000° C. In a typical embodiment, the elevated temperature may be in the range of 600-800° C. In some embodiments, the first and/or second environments may be at elevated pressures for at least some fraction of the time. In some embodiments, the elevated pressure may be above 100 psig. In some preferred embodiments, the elevated pressure may be above 500 psig, and as high as 15,000 psig. In a typical embodiment, the elevated pressure may be in the range of 1,000-5,000 psig, and more specifically 1,500-3,000 psig.

### BACKGROUND OF THE INVENTION

High-temperature heat exchangers are an enabling technology for advanced fossil energy power generation systems, such as systems that utilize power cycles based on steam or supercritical CO₂ (sCO₂). These applications require significant recuperation for high-efficiency, in addition to the heat input and removal required of any closed cycle to achieve desired performance sCO₂ closed Brayton cycles are being considered for advanced nuclear power plants, concentrating solar power (CSP), and advanced combustion power generation applications. Even in steam-based heat exchangers, higher operating temperatures and pressures are seen as a way to achieve higher efficiencies in fossil energy and nuclear power plants. While the specific designs and materials for the next generation of heat exchangers are different for different applications, the requirement to go to high temperatures and operating pressures creates new requirements for heat exchanger systems.

It is now well established that many of the low-cost alloys are corroded easily in sCO₂ at high temperatures above 700° C. and at high pressures. Similarly, high temperature hydrothermal corrosion of metals is also a problem that limits their use in high-temperature steam cycles. While there has been significant effort in developing advanced alloys with improved stability in these environments, these efforts have had limited success to date and while retardation of corrosion rates have been achieved, the achieved performance is nowhere close to what is needed for reliable and cost-effective performance in power plants.

On the other hand, ceramic heat exchangers made of silicon carbide and silicon nitride have been shown to have good stability in these operating environments. Although ceramic heat exchangers were conceived of over 30 years ago, cost and reliability concerns limited their adoption. A new generation of ceramic heat exchangers utilizing highly efficient microchannel designs and low-cost, high-volume fabrication methods have made these devices practical. However, ceramics have some negatives related to the cost of reliability as they generally have limitations in performance under tension and require specialized engineering when joining to other components. Effective ceramic-to-metal joining is a key technology gap for high-temperature heat exchangers that, if overcome, may enable designers to exploit the high temperature corrosion resistance of many ceramic materials for the core of the heat exchanger while utilizing lower cost metallic components to provide the balance of the required plumbing system.

A high-temperature, high-pressure, gas-tight seal between a ceramic heat exchanger and a metal pipe has the following requirements:

Hold fluid at elevated pressures without leaks or failures at high temperatures, for example 800° C.

Be thermochemically stable with respect to the environment and the materials used

Be capable of withstanding thermal cycles and rapid shutdowns without failure

To hold such high pressures at high temperature, novel sealing methods are needed. The requirement to maintain pressure during a temperature cycle results in some unique requirements that typical joining methods for SiC to metal are not able to meet.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings. While the various aspects of the embodiments are presented in drawings, the drawings are not necessarily drawn to scale unless specifically indicated.

FIG. 1 is a cross-sectional view of an example configuration for a ceramic-to-metal seal assembly.

FIG. 2 is a drawing of typical metal U-ring used to form seal between metal alloy tube and ceramic heat exchanger.

FIG. 3 is a drawing of an example design of a metal U-ring filled with cermet powder with an additional seal feature of a flat silver washer sealing a top-ring component to the metal component.

FIG. 4 shows a photo (a) of an assembled sample, schematics (b) of assembled parts, and a microscopic optical image (c) of the interface between U-ring and SiC rod.

FIG. 5 is a graph of thermal cycle results at 400° C. with 1400 psig. The values at 20° C. for each cycle are shown in blue (on left) and the values at 400° C. for each cycle are shown in red (on right).

FIG. 6 is a graph of thermal cycle results at 600° C. with 1400 psig. The values at 20° C. for each cycle are shown in blue (on left) and the values at 600° C. for each cycle are shown in red (on right).

FIG. 7 is a graph of thermal cycle results at 600° C. with 2700 psig. The values at 20° C. for each cycle are shown in blue (on left) and the values at 600° C. for each cycle are shown in red (on right).

FIG. 8 is a graph of leak test results at 700° C. with 1500 psig. The values at 20° C. for each cycle are shown in blue (on left) and the values at 700° C. for each cycle are shown in red (on right).

FIG. 9 is a graph of leak test results at 700° C. with 3000 psig. The values at 20° C. for each cycle are shown in blue (on left) and the values at 700° C. for each cycle are shown in red (on right).

FIG. 10 is a graph of leak test results at 750° C. with 3000 psig. The values at 20° C. for each cycle are shown in blue (on left) and the values at 750° C. for each cycle are shown in red (on right).

FIG. 11A is a graph of a pressure decay leak test at 50° C.

FIG. 11B is a graph of a pressure decay leak test at 800° C.

### DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

This invention describes methods and devices for high-temperature sealing. Some embodiments of this invention describe methods and devices for sealing metallic components to ceramic components. Some embodiments of this invention describe methods and devices for sealing such that a first environment containing one or more fluids may be isolated from at least one other environment containing one or more fluids. In some embodiments, the seal may be expected to operate at least part of the time at an elevated temperature. In some embodiments, the elevated temperature may be above 100° C. In some preferred embodiments, the elevated temperature may be above 300° C., and as high as 1000° C. In a typical embodiment, the elevated temperature may be in the range of 600-800° C. In some embodiments, the first and/or second environments may be at elevated pressures for at least some fraction of the time. In some embodiments, the elevated pressure may be above 100 psig. In some preferred embodiments, the elevated pressure may be above 500 psig, and as high as 15,000 psig. In a typical embodiment, the elevated pressure may be in the range of 1,000-5,000 psig, and more specifically 1,500-3,000 psig.

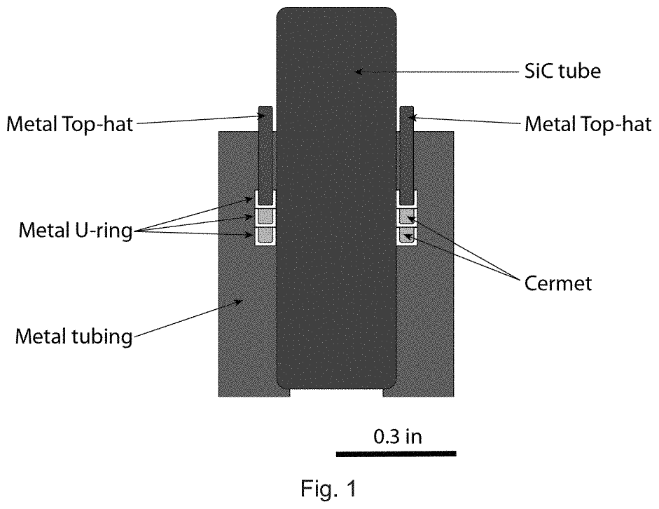

The details of the seal assembly are shown in FIG. 1. A seal consists of three metal U-rings with cermet powder loaded into the bottom two U-rings. The third U-ring on top serves as a cap to contain the cermet powder within the annulus of the 2nd U-ring. The assembly procedure begins by dip coating the SiC component with silver paste and while wet inserting the SiC component into the metal tube. Then, a metal U-ring is dip coated with silver paste and slipped over the SiC component, followed by pressing to push the U-ring down into the bottom of the gap that exists between the SiC component and metal tube part. This first U-ring is then filled with cermet powder, for example 250 mg, and compacted in place using a custom punch in order to form a dense powder compact of cermet powder inside the U-ring. The second U-ring and cermet powder were loaded by repeating the process. On top of the 2nd cermet powder compact another metal U-ring is pressed into place, this 3rd U-ring serving as a cap to contain the cermet powder within the U-ring. Finally, a stainless steel “top-ring” part is pressed into place which pushes the 3rd U-ring down into the cermet powder below completely compacting the entire seal system.

Some embodiments of this invention comprise a metal, U-shaped seal ring (U-ring) in conjunction with some component installed within the U-ring that pushes the metal seal ring firmly against both sealing surfaces (metal and ceramic) in such a way as to provide gas tight sealing across a wide range of temperatures. As used herein, the term “U-shaped seal ring” or “U-ring” includes other geometric shapes besides a “U-shaped” cross-section, such as a V-shaped, C-shaped, square-shaped, or any other geometric shape that will function as intended in the disclosed invention. In some embodiments, the preferred material for providing this sealing force is a cermet powder (i.e. a powder mixture comprising at least one metal powder and at least one ceramic powder) with a coefficient of thermal expansion (CTE) that is higher than either the ceramic or metal components that are being joined together. In some embodiments, the complete seal assembly (U-ring plus cermet) is designed to plastically deform and seal a gap between a metal tube and ceramic heat exchanger to maintain a high-pressure gas tight seal across a wide temperature range. As shown in Table 1, silicon carbide has a much lower thermal expansion (<3 ppm/° C.) relative to common high temperature metal alloys (12-18 ppm/° C.).

TABLE 1
Thermal expansion of silicon carbide relative to common metal alloys
and materials used as cermets for the U-ring seal component.

| Material | CTE (ppm/° C.) |
|---|---|
| SiC | 2.7-2.8 |
| Silver | 20 |
| MgO | 13 |
| 316 Stainless Steel | 15-18 |
| 304 Stainless Steel | 16-18 |
| 440C Stainless Steel | 10 |
| Inconel 600 | 12.4-13.1 |
| Inconel 625 | 12.8-13.4 |
| 25% Ag 75% MgO | 13-16 |
| 75% Ag 25% MgO | 16-19 |

The cermet seal material we propose has a higher CTE than either the metal alloys or the silicon carbide. In some embodiments, the cermet may comprise an oxide material. In some embodiments, the oxide material may comprise magnesium oxide, MgO (13 ppm/° K) and silver (20 ppm/° K). In some embodiments, the ceramic frame work is not sintered together, but is mixed with the metal powder and packed under pressure to form a gas tight compact that can be plastically deformed at elevated temperatures and pressures.

In some embodiments, when the seal is formed at room temperature in some embodiments, the joint design will allow for the cermet to be plastically deformed (by a hydraulic press, screw-tightening/locking or crimping operation) to make a gas-tight seal. This type of hybrid seal has a plastically deformable cermet ingredient that is contained within a metal ring that allows for rearrangement of the high thermal expansion powder under pressure thus providing a flexible seal that is capable of deforming as needed to maintain a gas-tight seal between the metal alloy tube and ceramic heat exchanger.

In some embodiments, once the high-pressure seal is formed at room temperature, during the heat up cycle, the metal alloy tube will expand more than the ceramic (e.g. SiC) opening up a gap. However, the cermet powder itself has a greater thermal expansion which will result in substantial forces on the seal ring that will force it to plastically deform and fill the gap and continue to form a compression seal that can maintain high pressure. On a cool-down cycle, this operation happens in reverse with the metal tube forcing the seal ring to deform back to its original shape.

Clearly, the choice of metal and ceramic for the cermet material is critical. A soft malleable metal with low yield stress is ideal, and silver is a good choice as fine-grained silver starts to plastically deform below 15 MPa at room temperature and as low as a few MPa by the time the temperature is over 200° C. It also has good oxidation resistance and excellent stability with SiC. Therefore, in some preferred embodiments, the cermet comprises silver or a silver alloy.

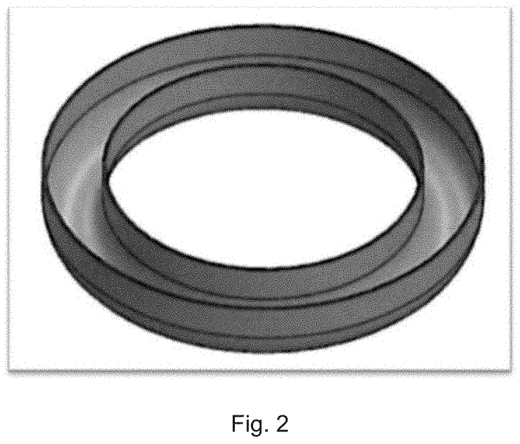

FIG. 1 shows cross-section view of one embodiment of a ceramic-to-metal seal with three (3) U-rings, two (2) cermet seals, and a top ring. Embodiments of this invention include metal seal rings which may have the shape of a “U” as shown in FIG. 2. The wall thickness of the metal in the U-ring may vary depending upon the specific design and size of the components to be sealed. The thickness may be in the range of 0.002 inches-0.040 inches depending on the seal design.

In some embodiments the material used to fabricate the “U-ring” is a pure silver foil. In another embodiment the material may be a Ag—Pd alloy, Ag—Cu alloy or other metal alloys such as Inconel, Hastelloy, or stainless steel as just a few examples.

Embodiments of this invention include cermet materials made from a mixture of two types of powder that is used to fill up the cavity within the U-ring. One powder is a ceramic powder, and the second powder is a metal powder.

In one embodiment the metal powder is silver, Ag.

In another embodiment the metal powder is a silver alloy. For example, silver may be alloyed with Palladium at different compositions to increase the melting temperature of the metal alloy powder. In another embodiment silver can be alloyed with another metal to lower the melting temperature, such as copper for example.

In one embodiment the ceramic component of the cermet is magnesium oxide (MgO).

In another embodiment the ceramic powder component of the cermet can be a complex oxide with a relatively high CTE (coefficient of thermal expansion) such as a perovskite material, for example, lanthanum strontium cobalt ferrite (LSCF, CTE>15 ppm/° K depending upon composition). Other complex oxides may also include materials from the group of double perovskite materials which have CTE as high as 20.7 ppm/° K, for example Praseodymium Barium Calcium Cobaltite (PBCC).

In one embodiment the cermet material consists of a mixture of metal powder, such as silver powder, and a ceramic powder, such as MgO. The mixture can range all the way from 0.01% to 99.99% for each of the two constituents.

In another embodiment the cermet material is a single-phase material and not a mixture, for example pure Ag, Ag—Pd alloy, MgO, or LSCF powder as just a few examples.

In another embodiment the cermet material that fills the metal U-ring may be replaced with a metallic O-ring of various configurations. For example, commercially available metal O-rings from companies such as Daemar Inc. provide metallic O-rings in three configurations for various applications. One is a simple metal tube or rod formed into an O-ring made of specific metal alloys, in this application a high CTE metal alloy is selected. Alternatively, a second configuration is available where a hollow metal O-ring is fabricated with small pin holes facing the high-pressure side of the seal. This “self-energizing” configuration utilizes the gas pressure from the application to pressurize and expand the metal O-ring. In this embodiment the expanding O-ring provides pressure against the metal U-ring to further provide gas tight sealing. The third potential O-ring configuration is a “pressure filled” O-ring in which the O-ring is fabricated to contain pressurized gas, for example 600 psi at room temperature. In this embodiment as the seal is heated the pressure filled O-ring gas pressure increases as a function of temperature and exerts a strong force on the metal U-ring to further enhance the gas tight seal.

Embodiments of this invention use one or more metal U-rings filled with a cermet powder to fill the space between two components to be joined as shown in FIG. 1. The U-ring and cermet powder are installed into the space between the components to be sealed by either a pressing operation (such as a hydraulic press), crimping, screw turning or other method capable of applying a force to the U-ring/cermet and compacting/compressing the U-ring/cermet to tightly fill the gap between the two components to be sealed.

In some embodiments the seal is formed at room temperature by installing the components together and applying the load to plastically deform the seal. In other embodiments, the components are assembled together at room temperature but are then loaded into an apparatus that is capable of applying the load at elevated temperatures in order to more easily deform the seal into place and form the gas tight junction. When the seal is formed at elevated temperature it is considered that the heat and applied pressure result in diffusion bonding of the components resulting in a stronger bond between the sealing components.

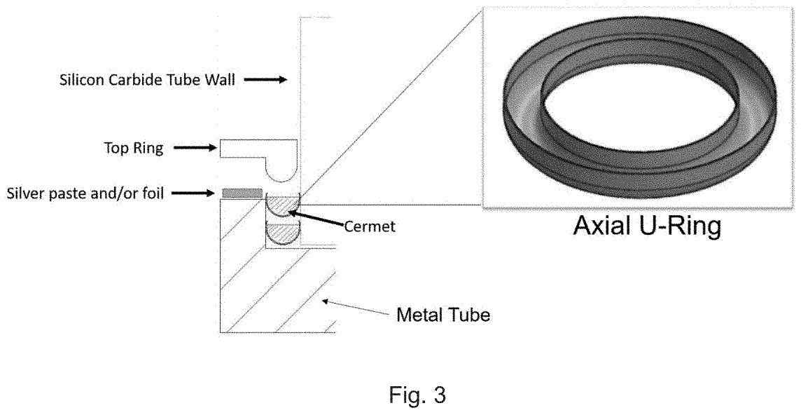

In some embodiments the design shown in FIG. 1 has an additional feature of adding a silver washer with silver paste between the top ring part and the metal tube part as shown in FIG. 3. During the diffusion bonding step the sample is heated to a high temperature in the range of 600-1200° C. depending upon the materials used with a load applied to the top ring which compresses the U-ring/cermet components into the space between the SiC component and the metal tube component. The applied load is in the range of 10-2,000 lbs. and maintained at the selected load for a time period of 1-600 minutes depending on the size of the components being sealed. In addition, in some embodiments the high temperature sealing operation is performed in an air atmosphere and in other cases it is performed in an inert atmosphere such as flowing nitrogen or argon, or under vacuum. During this high temperature sealing step there is a bond being formed between the metal top ring and the metal tube and there is also a bond being formed between the SiC component and the metal U-ring. This bond is an integral part of the seal system and contributes to the gas tight behavior of the seal.

To demonstrate the concept for the ceramic to metal seal, components were fabricated, a seal was formed at elevated temperatures using the high temperature sealing method and pressure decay leak tests were performed.

### Example 1

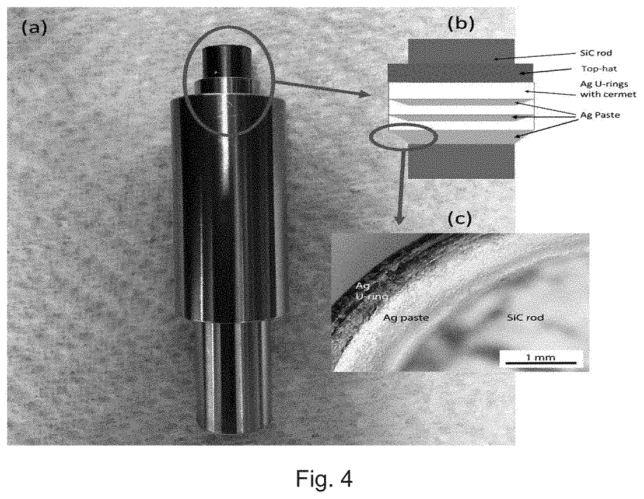

1. All of parts (stainless steel 440 C tube, silver U-rings, and stainless steel 316 top-hat) were cleaned in alcohol by ultrasonication for 3 min. The parts were dried by air flow. The cleaning process was repeated two more times.
2. Silver (Ag) paste was brush coated on the silicon carbide (SiC) rod and metal tube surfaces.
3. The coated SiC rod was inserted in the stainless steel tube.
4. The U-ring was inserted in the gap between the SiC rod and the stainless steel tube.
5. Then 250 mg of the cermet (75 wt. % Ag and 25 wt. % MgO) was added in the cavity of the U-ring.
6. The next U-ring was inserted in the gap between the SiC rod and the stainless steel tube.
7. The ring was pressed down at 0.2 tons holding the applied load for 10 min.
8. Ag paste was applied again to the SiC rod surface because some of the coating gets scratched off by installation of the U-rings.
9. Steps 5-8 are then repeated to form a second cermet/U-ring seal component on top of the first.
10. The top-hat was inserted on top of the last U-ring and pressed down at 0.2 tons for 10 min.
11. The sample was heated to 500° C. at 5° C./min and held at temperature for 20 minutes in air to burn out the solvent and binders from the silver paste.
12. Next the chamber in which the seal was formed was flushed with nitrogen gas and then the temperature was increased to 900° C. The top-hat was pressed at 0.5 tons at 900° C. under N₂ atmosphere for 3 hours. The assembled parts are shown in FIG. 4.

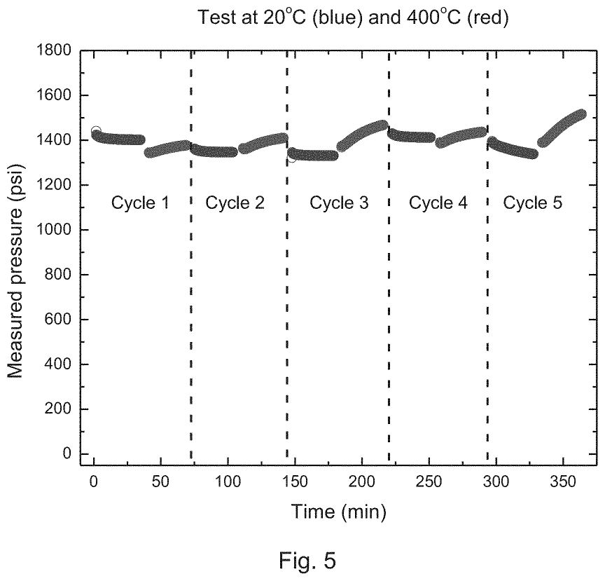

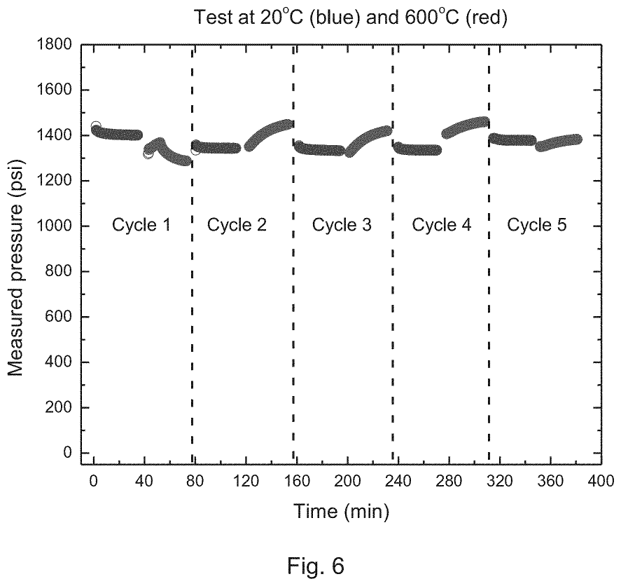

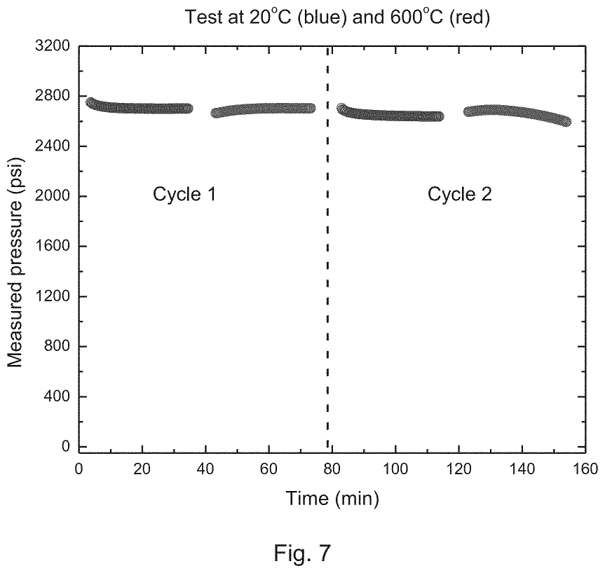

Leak testing was performed at room temperature, 400° C. and 600° C. to characterize the seal performance. The leak test procedure is to pressurize the high pressure side of the fabricated seal with N₂ gas, close the shut-off valve and measure the pressure decay for 30 min. Results from the leak testing are shown in FIGS. 5 and 6 at pressures of about 1500 psig where the sample was tested and heated through five thermal cycles to demonstrate a leak tight seal with thermal cycling capability. The sample was then tested at a higher pressure of 2700 psig and two thermal cycles were performed with leak testing, the test results shown in FIG. 7 indicate the seal is gas tight at the higher pressure.

### Example 2

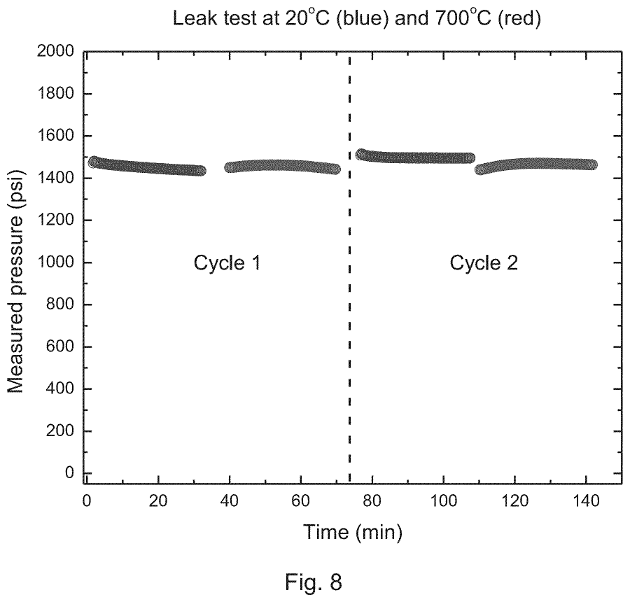

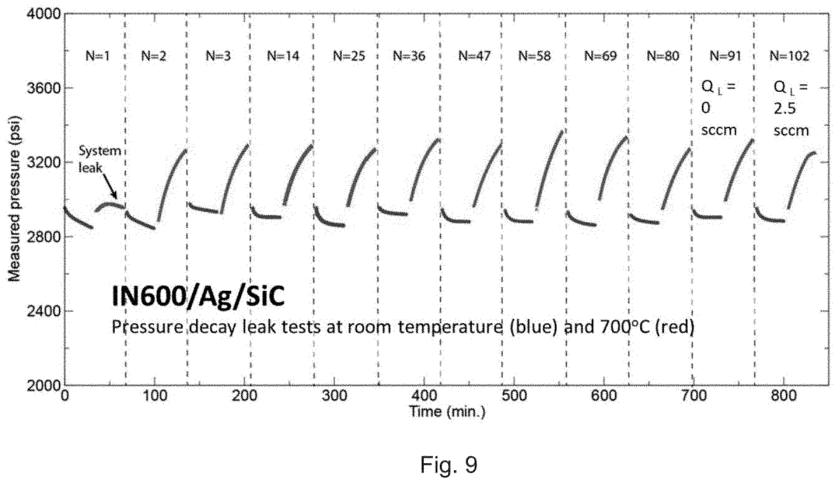

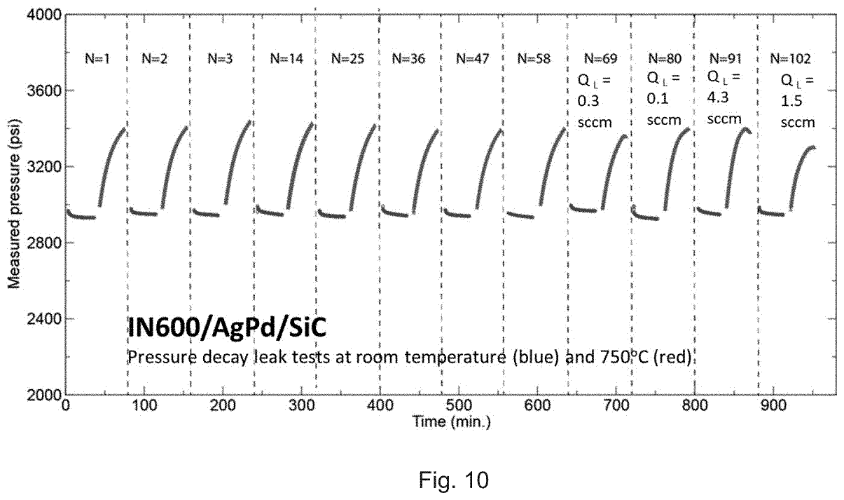

A seal test sample was fabricated using the same materials and procedures as used in example 1 with one minor modification. In this sample the SiC rod was dip coated with Ag in step 2 as opposed to brush coated to make a more uniform and even coating of Ag on the SiC component. Leak testing was performed at room temperature and 700° C. or 750° C. to characterize the seal performance. The leak test procedure is to pressurize the high-pressure side of the fabricated seal with N₂ gas, close the shut-off valve and measure the pressure decay for 30 min. Results from the leak testing are shown in FIGS. 8, 9, and 10 where the sample was tested and heated through two or more thermal cycles to demonstrate a leak tight seal with thermal cycling capability.

### Example 3

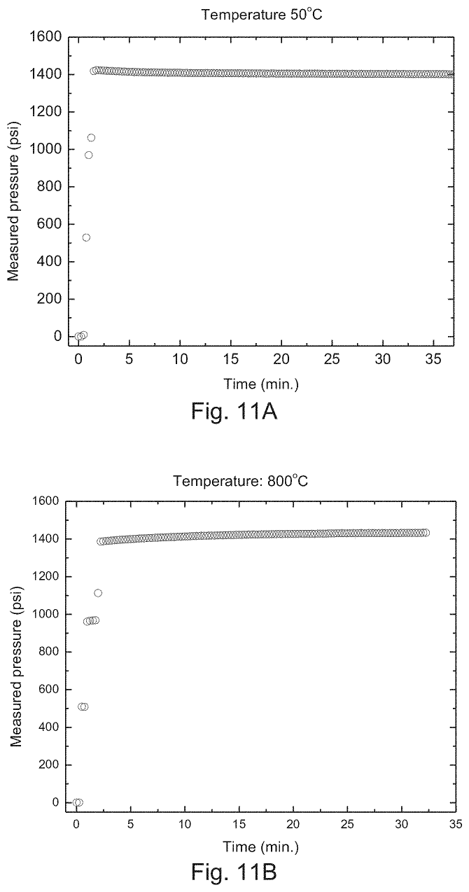

A seal test sample was fabricated using the same materials and procedures as used for Example 2. For this sample the seal capability was tested at higher temperatures, specifically, 800° C. The sample was first tested at 50° C. to verify a tight seal at near room temperature. Next, the sample was heated to 800° C. and the pressure decay leak test was performed again. The results shown in FIGS. 11A and 11B indicate that the seal is leak tight at 800° C.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A high temperature seal for sealing a metallic component to a ceramic component comprising a plurality of stacked metal rings having a U-shaped cross section, wherein one or more lower rings contains a cermet powder within the U-shaped cross section and an upper ring is positioned over the one or more lower rings to serve as a cap to contain the cermet powder within the one or more lower rings.

2. A high temperature seal according to claim 1, further comprising a supplemental upper ring ring disposed over the upper ring.

3. A high temperature seal according to claim 1, wherein the supplemental upper ring comprises a high temperature material selected from glass, ceramic, or metal.

4. A high temperature seal according to claim 1, wherein the plurality of stacked metal rings comprise silver.

5. A high temperature seal according to claim 1, wherein the plurality of stacked metal rings comprise a silver alloy.

6. A high temperature seal according to claim 1, wherein the cermet powder comprises silver or a silver alloy.

7. A high temperature seal according to claim 1, wherein the cermet powder comprises magnesium oxide or a complex metal oxide with a coefficient of thermal expansion greater than 15 ppm/° K.

8. A high temperature seal according to claim 1, wherein the cermet powder comprises Ag and MgO.

9. A method of fabricating a high temperature seal for sealing a metallic component to a ceramic component comprising:
coating a sealing surface of the ceramic component with silver paste;
inserting the ceramic component into the metallic component, wherein the silver paste is disposed between the sealing surface of the ceramic component and a sealing surface of the metallic component;
placing a first sealing ring around the ceramic component, wherein the first ring is disposed between the sealing surface of the ceramic component and the sealing surface of the metallic component;
disposing and compacting cermet powder within the cross section of the first ring;
placing a second sealing ring around the ceramic component and on top of the first sealing ring, wherein the sealing ring is disposed between the sealing surface of the ceramic component and the sealing surface of the metallic component;
disposing and compacting cermet powder within the cross section of the second sealing ring;
placing a third sealing ring over the second ring to cap the cermet powder within the second sealing ring, wherein the third ring is disposed between the sealing surface of the ceramic component and the sealing surface of the metallic component;
placing a fourth ring over the third ring; and
compacting the assembly of rings.

10. A method of fabricating a high temperature seal according to claim 9, wherein the assembly of rings was compressed at a temperature in the range of 600-1200° C.

11. A method of fabricating a high temperature seal according to claim 10, wherein the assembly of rings was compressed at a pressure greater than 100 psig.

12. A method of fabricating a high temperature seal according to claim 10, wherein the assembly of rings was compressed at a pressure in the range of 1,000-5,000 psig.

13. A method of fabricating a high temperature seal according to claim 10, wherein the assembly of rings was compressed for a time period in the range of 1 to 600 minutes.

14. A method of fabricating a high temperature seal according to claim 9, wherein the first, second, and third rings comprise silver.

15. A method of fabricating a high temperature seal according to claim 9, wherein the first, second, and third rings comprise a silver alloy.

16. A method of fabricating a high temperature seal according to claim 9, wherein the cermet powder comprises silver or a silver alloy.

17. A method of fabricating a high temperature seal according to claim 9, wherein the cermet powder comprises magnesium oxide or a complex metal oxide with a coefficient of thermal expansion greater than 15 ppm/° K.
